(19) United States
(12) Patent Application Publication
(10) Pub. No.: US 2007/0026888 A1
(43) Pub. Date: Feb. 1, 2007

(54) Mobile communication device provided with a locking mechanism

(75) Inventor: Cui-Yu Zhou, Shanghai City (CN)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/494,519

(22) Filed: Jul. 28, 2006

(30) Foreign Application Priority Data
Jul. 29, 2005 (TW) 94125827

(51) Int. Cl. H04M 1/00

(52) U.S. Cl. 455/550.1

(57) ABSTRACT

A mobile communication device includes a covering lid assembled to on a main body. The lid has a reception room and a pivot seat seated in the reception room. A slide button is mounted on the lid and is exposed from the reception room. An urging member is attached to the slide button to provide a restorative force. A hooking tongue is fixed to the slide button and is received within the reception room for engaging with and disengaging from an engaging member in the main body. A pivot unit is fixed to the slide button and extends slidably into the pivot seat of the lid. Movement of the button relative to the lid after pressing the button against the urging member results in engagement between the hooking tongue and the engaging member and disengagement between the hooking tongue and the engaging member.

### FIELD OF THE INVENTION

The invention relates to a locking mechanism, and more particularly to the locking mechanism for locking a covering lid onto a main body of a communication apparatus.

### BACKGROUND OF THE INVENTION

Due to rapid advance in the digital technology, the core elements, such as CPU (central processing unit) or DRAM (dynamic random access memory), are manufactured in compact according to the increased functions. The development of the System on Chip has entered a mature stage and the peripheral devices of the personal computer are in the trend to be manufactured in compact as the manufacturing process developed. A communication apparatus (herein after will be called a mobile communication device) becomes an essential digital electronic instrument for every person to be carried along with him. In addition to the communication ability, more and more functions are incorporated into the digital electronic instrument in order to attract the attention of the consumers and the markets. Lightweight and compact design are therefore taken into account during the manufacturing process.

A battery is employed in the mobile communication device is usually removed for recharging of the same. Presently, the covering lid for covering the battery chamber in the mobile communication device is pushed respect to the main body in order to remove or lock the same relative to the main body.

Referring to FIGS. 1A and 1B, a conventional mobile communication device 1 is shown to include a main body 11 and a covering lid 12. The main body 11 is further provided with a locking mechanism 13 for lock and unlocking the covering lid 12 relative to the main body 11. The covering lid 12 has one end portion formed with a retention groove 121. The locking mechanism 13 includes a holding seat 131 mounted movably on the main body 11 and a hooking tongue 132 projecting from one end of the holding seat 131. The holding seat 131 is movable limitedly outward of the main body 11 from its initial position upon receipt of an external force and returns to the initial position by virtue of a restorative force and upon removal of the applied force therefrom. When the covering lid 12 is mounted on the main body 11, the hooking tongue 132 extends into the retention groove 121 in the covering lid 12, thereby locking the covering lid 12 on the main body 11.

During mounting assembly of the covering lid 12 on the main body 11, the holding seat 131 is pushed outward limitedly so as to permit extension of the covering lid 12 into a predetermined position relative to the main body 11. Upon reaching the predetermined position, the covering lid 12 is locked onto the main body 11 since the hooking tongue 132 extends into the retention groove 121 in the covering lid 12 by virtue of the restorative force. Referring again to FIG. 1B, when it is desired to unlock the covering lid 12 relative to the main body 11, the holding seat 131 is pushed outward so as to release the hooking tongue 132 from the retention groove 121 in the covering lid 12. Under this condition, the covering lid 12 can be removed from the main body 11.

In the aforesaid conventional mobile communication device 1, the main body 11 must reserve a length space of 1.5 mm to 2 mm to permit movement of the holding seat 132 in addition to the space already occupied by the locking mechanism 13. It is against the trend of the object to be manufactured in compact by the manufacturers.

### SUMMARY OF THE INVENTION

It is the object of the present invention to provide a locking mechanism for locking a covering lid on a main body in a mobile communication device. The locking mechanism is simple in structure so that the reserved space required by the main body is eliminated, thereby providing a smaller compact size when compared to the conventional mobile communication device.

In one aspect of the present invention, a locking mechanism for locking a covering lid onto a main body is provided. The covering lid is formed with a reception room, and has a pivot seat disposed in the reception room. The main body has an engaging member. The locking mechanism includes a slide button, an urging member, a hooking tongue and a pivot unit. The slide button is used for attaching to the covering lid such that the slide button is exposed from the reception room. The urging member is attached to a lower surface of the slide button to provide a restorative force once an applied force is removed from the slide button. The hooking tongue is fixed to the lower surface of the slide button, and is received within the reception room in the covering lid for engaging and disengaging with the engaging member of the main body. The pivot unit is fixed to the lower surface of the slide button and extends slidably into the pivot seat of the covering lid. Movement of the slide button relative to the covering lid after pressing the slide button against urging action of the urging member results in engagement between the hooking tongue and the engaging member so as to lock the covering lid on the main body, and disengagement between the hooking tongue and the engaging member so as to unlock the covering lid from the main body.

In another aspect of the present invention, a communication apparatus is provided to include a main body, a covering lid and a locking mechanism. The main body is formed with an engaging member. The covering lid covers the main body, and is formed with a reception room. The covering lid has a pivot seat disposed within the reception room. The locking mechanism includes a slide button, an urging member, a hooking tongue and a pivot unit. The slide button is used for attaching to the covering lid such that the slide button is exposed from the reception room. The urging member is attached to a lower surface of the slide button to provide a restorative force once an applied force is removed from the slide button. The hooking tongue is fixed to the lower surface of the slide button, and is received within the reception room in the covering lid for engaging with and disengaging from the engaging member of the main body. The pivot unit is fixed to the lower surface of the slide button and extends slidably into the pivot seat of the covering lid. Movement of the slide button relative to the covering lid after pressing the slide button against urging action of the urging member results in engagement between the hooking tongue and the engaging member so as to lock the covering lid on the main body and disengagement between the hooking tongue and the engaging member so as to unlock the covering lid from the main body.

### BRIEF DESCRIPTION OF THE DRAWINGS

Other features and advantages of this invention will become more apparent in the following detailed description of the preferred embodiment of this invention, with reference to the accompanying drawings, in which:

FIG. 1A is an exploded view of a conventional mobile communication device;

FIG. 1A is a perspective view of a the conventional mobile communication device;

FIG. 2 is a bottom and enlarged view of a locking mechanism for employment in a mobile communication device of the present invention;

FIG. 3 is a perspective view of the mobile communication device of the present invention;

FIG. 4A is a fragmentary view of a covering lid and the locking mechanism employed in the mobile communication device of the present invention;

FIG. 4B is a perspective view of the covering lid provided with the locking mechanism in the mobile communication device of the present invention;

FIG. 5 is a perspective view of a main body in the mobile communication device of the present invention;

FIG. 6A is a fragmentary sectional view illustrating the covering lid at an unlocked position relative to the main body in the mobile communication device of the present invention;

FIG. 6B A is a fragmentary sectional view illustrating how a slide member is manipulated in order to accomplish locking and unlocking of the covering lid relative to the main body in the mobile communication device of the present invention; and

FIG. 6C is a fragmentary sectional view illustrating the covering lid at a locked position relative to the main body in the mobile communication device of the present invention.

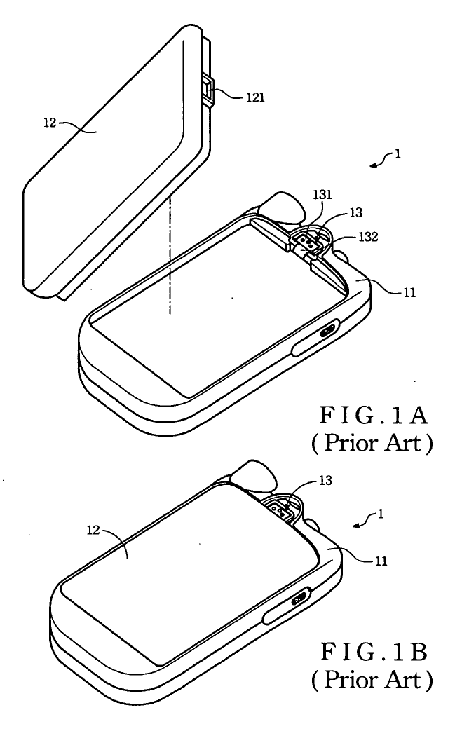

### DETAILED DESCRIPTIONS OF THE PREFERRED EMBODIMENT

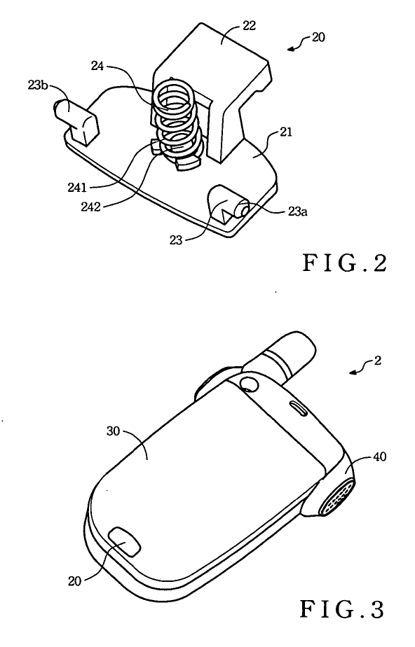

FIG. 3 shows a communication apparatus 2 (hereinafter a mobile communication device) of the present invention is shown to include a main body 40, a covering lid 30, a locking mechanism 20 (see FIG. 2). Referring to FIG. 2, for better understanding of the present invention, the locking mechanism 20 is turned upside down to illustrate the elements forming the same. The locking mechanism 20 accordingly includes a slide button 21, a hooking tongue 22, a pivot unit 23 and an urging member 24. A holding stick 242 projects downwardly from a lower surface of the slide button 21. The urging member 24 in fact is a spring 242 sleeved around the holding stick 242 for providing a restorative force so that the slide button 21 can return to its normal position (initial state) upon release of the applied force. The hooking tongue 22 is fixed to the lower surface of the slide button 21. The pivot unit 23 is fixed to the lower surface of the slide button 21 at a lateral side thereof. The pivot unit 23 includes two pins 23a, 23b projecting outwardly from two lateral sides of the slide button 21. Each of the pins 23a, 23b is cylindrical in cross-section.

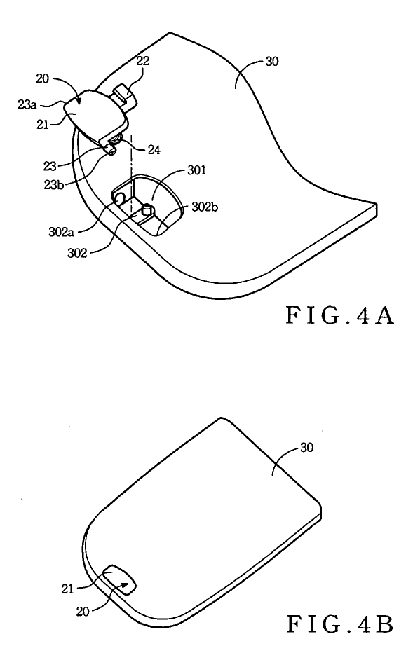

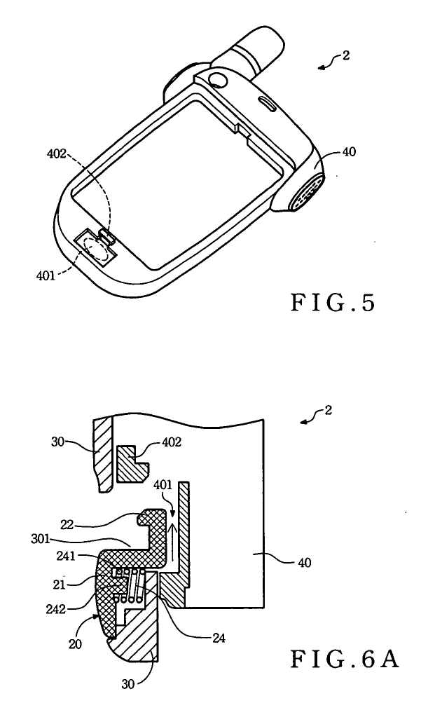

The main body 40 is formed with a reception compartment 401 that receives an engaging member 402 stationarily therein (see FIG. 5). The covering lid 30 is assembled to the main body 30 to confine a battery therebetween. The covering lid 30 is formed with a reception room 301 that is spatially interconnected with the reception compartment 401 in the main body 40 once the covering lid 30 covers the main body 40, as best shown in FIG. 3. The covering lid 30 further has a pivot seat 302 disposed within the reception room 301. The pivot seat 302 is formed with two pivot slots 302a, 302b (see FIG. 4A).

Referring to FIGS. 4A and 4B, after assembly of the locking mechanism 20 of the present invention on the covering lid 30, the slide button 21 is exposed from the reception room 301 in the covering lid. The pins 23a, 23b of the pivot unit 23 extend respectively and slidably into the pivot slots 302a, 302b in the pivot seat 302 so as to permit sliding action of the slide button 21 relative to the covering lid 30. The spring 242 is slidable contact with a bottom surface of the reception room 301 in order to provide the restorative force upon removal of the applied force from the slide button 21. The hooking tongue 22 is received within the reception room 301 in the covering lid 30 for engaging with and disengaging from the engaging member 402 of the main body 40.

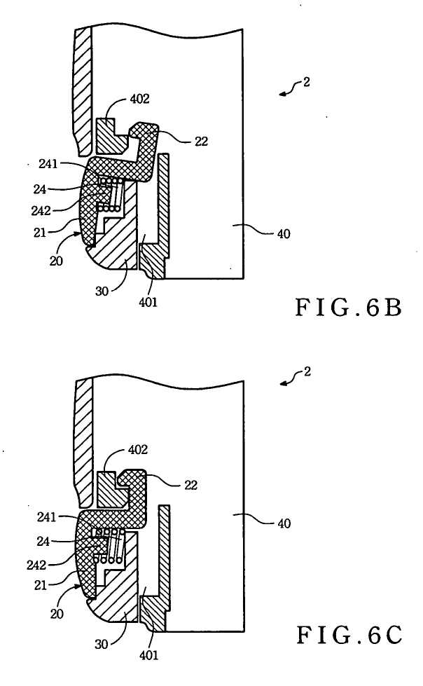

Referring to FIG. 6A, when it is desired to lock the covering lid 30 relative to the main body 40 so as to confine the battery (not shown) therebetween, the slide button 21 is pushed forward in the arrow direction relative to covering lid 30 after pressing the slide button 21 against urging action of the spring 242. Upon reaching a predetermined position on the covering lid 30 as shown in FIG. 6B, the applied force on the slide button 21 is removed such that the slide button 21 retrieves its normal position (or initial state) due to the restorative force. At the predetermined position, since the hooking tongue 22 is disposed immediately below the engaging member 402 in the main body 40, removal of the applied force from the slide button 21 results in engagement between the hooking tongue 22 and the engaging member 402 so as to lock the covering lid 30 on the main body 40. Under this condition, the covering lid 30 cannot be removed from the main body 40.

When it is desired to unlock the covering lid 30 from the main body 40 in case of removing or replacing the battery or for charging the same, the covering lid 30 is pressed downward against the urging action of the spring so as to disengage the hooking tongue 22 from the engaging member 402. The slide button 21 is then pushed rearward relative to covering lid 30 such that the hooking tongue 22 moves together with the slide button 21 away from the engaging member 402, thereby unlocking the covering lid 30 with respect to the main body 40. Thus, the covering lid 30 can be removed from the main body 40.

In this embodiment, the main body 40 is further formed with a battery chamber. Alternately, the covering lid 30 can be formed with a battery chamber in order to receive the battery therein prior to mounting on the main body 40.

The following advantages can be achieved when the locking mechanism 20 is employed in the mobile communication device 2 of the present invention.

(1) The main body 40 can be manufactured in a relatively compact size since the engaging member 402 is formed within an interior thereof. There is no need to reserve the length space of 1.5 mm to 2 mm as required by the main body of the conventional mobile communication device.

(2) The manufacture cost can be reduced since the components for forming the locking mechanism 20 does not required complicated process, but rather can be formed by traditional tools and methods.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A locking mechanism for locking a covering lid onto a main body, the covering lid having a reception room and a pivot seat disposed in the reception room, the main body having an engaging member, the locking mechanism comprising:
a slide button for attaching to the covering lid such that said slide button is adapted to be exposed from the reception room;
an urging member attached to a lower surface of said slide button to provide a restorative force once an applied force is removed from said slide button;
a hooking tongue attached to said lower surface of said slide button, and adapted to be received in the reception room in the covering lid for engaging with and disengaging from the engaging member of the main body; and
a pivot unit attached to said lower surface of said slide button and adapted to extend slidably into the pivot seat of the covering lid;
wherein, movement of said slide button relative to the covering lid upon pressing said slide button against urging action of said urging member results in engagement between said hooking tongue and the engaging member so as to lock the covering lid into the main body and disengagement between said hooking tongue and the engaging member so as to unlock the covering lid from the main body.

2. The locking mechanism according to claim 1, further comprising a holding stick projecting downwardly from said lower surface of said slide button, wherein said urging member includes a spring sleeved on said holding stick for providing said restorative force.

3. The locking mechanism according to claim 1, wherein the pivot seat is formed with two pivot slots and said pivot unit includes two pins projecting slidably and respectively into the pivot slots in the pivot seat.

4. The locking mechanism according to claim 1, wherein the main body is formed with a reception compartment that receives the engaging member stationarily and that is spatially interconnected with the reception room in the covering lid once the covering lid covers the main body.

5. The locking mechanism according to claim 1, wherein the covering lid and the main body confine a battery therebetween when the covering lid covers the main body.

6. The locking mechanism according to claim 5, wherein the main body is formed with a battery chamber for receiving the battery.

7. The locking mechanism according to claim 5, wherein the covering lid further includes a battery chamber for receiving the battery.

8. The locking mechanism according to claim 1, wherein the locking mechanism is used in a mobile communication device consisting of the covering lid and the main body with the covering lid and the main body cooperatively confining a battery therebetween.

9. A communication apparatus comprising:
a main body formed with an engaging member;
a covering lid for covering said main body and formed with a reception room and a pivot seat disposed within said reception room; and
a locking mechanism including
a slide button mounted to said covering lid in such a manner that said slide button is exposed from said reception room in said covering lid,
an urging member attached to a lower surface of said slide button to provide a restorative force once an applied force is removed from said slide button,
a hooking tongue attached to said lower surface of said slide button so as to be received within said reception room in said covering lid for engaging with and disengaging from said engaging member of said main body, and
a pivot unit attached to said lower surface of said slide button and extending slidably into said pivot seat of said covering lid;
wherein, movement of said slide button relative to said covering lid upon pressing said slide button against urging action of said urging member results in engagement between said hooking tongue and said engaging member so as to lock said covering lid into said main body and disengagement between said hooking tongue and said engaging member so as to unlock said covering lid from said main body.

10. The communication apparatus according to claim 9, wherein said locking mechanism further includes a holding stick projecting downwardly from said lower surface of said slide button, said urging member being a spring sleeved securely on said holding stick for providing said restorative force.

11. The communication apparatus according to claim 9, wherein said pivot seat is formed with two pivot slots and said pivot unit includes two pins projecting slidably and respectively into the pivot slots in said pivot seat.

12. The communication apparatus according to claim 9, wherein said main body is formed with a reception compartment that receives said engaging member and that is spatially interconnected with said reception room in said covering lid when said covering lid covers said main body.

13. The communication apparatus according to claim 9, wherein said covering lid and the main body confine a battery therebetween when said covering lid covers said main body.

14. The communication apparatus according to claim 13, wherein said main body is formed with a battery chamber.

15. The communication apparatus according to claim 13, wherein said covering lid is formed with a battery chamber.

16. The communication apparatus according to claim 9, wherein the communication apparatus is a mobile communication device consisting of said covering lid and said main body cooperatively confining a battery therebetween.
